(19) United States
(12) Patent Application Publication
(10) Pub. No.: US 2022/0314936 A1
(43) Pub. Date: Oct. 6, 2022

(54) WIPER ARM FOR A WIPER SYSTEM OF A VEHICLE AND METHOD FOR MANUFACTURING A WIPER ARM

(71) Applicant: Valeo Systèmes d'Essuyage, Le Mesnil Saint Denis (FR)

(72) Inventors: Joerg Danko, Bietigheim (DE); Edgar Leis, Bietigheim (DE)

(73) Assignee: Valeo Systèmes d'Essuyage, Le Mesnil Saint Denis (FR)

(21) Appl. No.: 17/639,714

(22) PCT Filed: Jul. 22, 2020
(86) PCT No.: PCT/EP2020/070731

§ 371 Date: Mar. 2, 2022

(30) Foreign Application Priority Data
Sep. 6, 2019 (DE) 10 2019 123 942.7

(51) Int. Cl. B60S 1/34; B21D 7/00

(52) U.S. Cl. CPC B60S 1/3429; B60S 1/3434; B60S 1/3447; B60S 1/3468; B60S 1/3415; B21D 7/00

(57) ABSTRACT

The invention relates to a wiper arm (10) for a wiper system of a vehicle, having a wiper arm element (12) which is configured for connecting, in an articulated manner, an attachment piece (20) coupled to a wiper shaft, wherein the wiper arm element (12) is coupled to an adapter element (18) for connecting to a wiper blade. Furthermore, it is provided that the wiper arm element (12) consists of two separate components (14, 16), namely a first component (14), which is connected to the adapter element (18), and a second component (16), which attaches to the first component (14) on the side facing away from the adapter element (18), and that the first component (14) is formed from a profile strip (37) having a U-shaped cross section, wherein the two components (14, 16) overlap in a longitudinal direction in a first connection area (24).

### TECHNICAL FIELD

The invention relates to a wiper arm for a wiper system of a vehicle, as is used in particular in the region of a front windscreen of a vehicle. Furthermore, the invention relates to a method for manufacturing a wiper arm according to the invention.

### PRIOR ART

DE 10 2016 206 159 A1 discloses a wiper arm for a wiper system of a vehicle with the features of the preamble of Claim 1. The known wiper arm has a wiper arm element which is configured for connecting, in an articulated manner, an attachment piece coupled to a wiper shaft, wherein the wiper arm element is coupled to an adapter element for connecting the wiper arm element to a wiper blade. Furthermore, such wiper arms known from the prior art frequently serve to supply a cleaning medium to a spray nozzle arranged on the wiper blade. For this purpose, a hose which is connected to a storage reservoir for the cleaning medium (washing water) is arranged on the wiper arm element, with the intention being that the hose is protected as far as possible against external influences and is arranged in a visually non-perceptible manner on the wiper arm element.

### DISCLOSURE OF THE INVENTION

The wiper arm according to the invention for a wiper system of a vehicle with the features of Claim 1 has the advantage that, in addition to its suitability for the arrangement of at least one hose for a cleaning medium and optionally heating wires for a heatable wiper blade, it can be adapted in a particularly simple manner to the respective intended use or to the windscreen geometry and to the vehicle by a type of modular construction. For this purpose, the teaching of the invention makes provision for the wiper arm element to consist of two separate components, namely a first component, which is connected to the adapter element for the wiper blade, and a second component, which attaches to the first component on the side facing away from the adapter element, and that the first component is formed from a profile strip having a U-shaped cross section, wherein the two components of the wiper arm element overlap in a longitudinal direction in a first connection area.

Owing to the fact that the wiper arm element consists of two interconnected components between the attachment piece and the adapter element, the wiper arm element or the geometry thereof can be adapted particularly simply to the respective intended purpose. For example, it is possible very simply to extend or to reduce the length of the wiper arm by means of the size of the overlap between the two components of the wiper arm element, for adaptation to the use situation.

Advantageous developments of the wiper arm according to the invention for a wiper system of a vehicle are provided in the dependent claims.

A particularly preferred refinement of the adapter element connected to the wiper arm element, said refinement making it possible to arrange the hose for the cleaning medium or the heating wires in a protected manner in the wiper arm right up to the wiper blade, provides that the adapter element has, at least on the side facing the first component of the wiper arm element, a U-shaped cross section, wherein the first component of the wiper arm element and the adapter element overlap in a longitudinal direction in a second connection area.

There are various possibilities with regard to the connection of the individual elements of the wiper arm. In a first refinement, it is provided that the two components of the wiper arm element and the adapter element are made of metal and connected to one another by welds.

Alternatively thereto, it is also conceivable for the two components of the wiper arm element to be made of metal and to be connected to one another by at least one weld, for the adapter element to be made of plastic, and for the wiper arm element and the adapter element to be connected to one another by a snap-on connection or a bonded connection.

In a preferred geometric configuration of the wiper arm element, it is provided that the first component of the wiper arm element has two sections arranged parallel to each other, which are connected to each other by a diagonally positioned intermediate section.

Furthermore, it is preferably provided that the cross section of the first component of the wiper arm element is received in the two connection areas in a form-fitting manner inside the U-shaped cross section of the adapter element and of the second component of the wiper arm element.

During the operation, a wiper arm requires a certain contact pressure force in order to press the wiper arm or the wiper blade connected to the wiper arm against the vehicle windscreen. For this purpose, it is preferably provided that a fastening element for a spring element is arranged on the first component of the wiper arm element on the side facing the second component of the wiper arm element, wherein the fastening element protrudes axially above the end face of the first component facing the second component and is received inside the U-shaped cross section of the second component.

The wiper arm described to this extent is suitable in particular for receiving at least one hose for a cleaning medium and optionally heating wires for heating the wiper blade. Said elements are arranged here in a protected manner in the cross section of the wiper arm element.

In a development of the proposal just made, it is provided that the at least one hose for the cleaning medium is held or positioned in the wiper arm element by a clamping action connection.

The invention also comprises a method for manufacturing a wiper arm according to the invention that has been described to this extent, wherein the method is distinguished in that the first component of the wiper arm element is reshaped, by a bending process, from a metal profile strip having a U-shaped cross section from a rectilinear original state into a final form.

In a development of the manufacturing method, it is provided that the bending process of the profile strip is effected in a plane extending parallel to a base section of the profile strip.

Further advantages, features and details of the invention will emerge from the following description of preferred exemplary embodiments and with reference to the drawings.

### BRIEF DESCRIPTION OF THE DRAWINGS

FIG. 1 shows a wiper arm element in a top view,

FIG. 2 shows the wiper arm element according to FIG. 1 with an attachment piece fastened thereto and hoses arranged inside the cross section of the wiper arm element for a cleaning medium or heating wires for a wiper blade,

FIG. 3 shows an end region of the wiper arm element in a top view, and

FIG. 4 shows a cross section through the wiper arm element to clarify the arrangement of hoses and heating wires arranged in the wiper arm element.

### EMBODIMENTS OF THE INVENTION

Identical elements or elements having an identical function are provided with the same reference numbers in the figures.

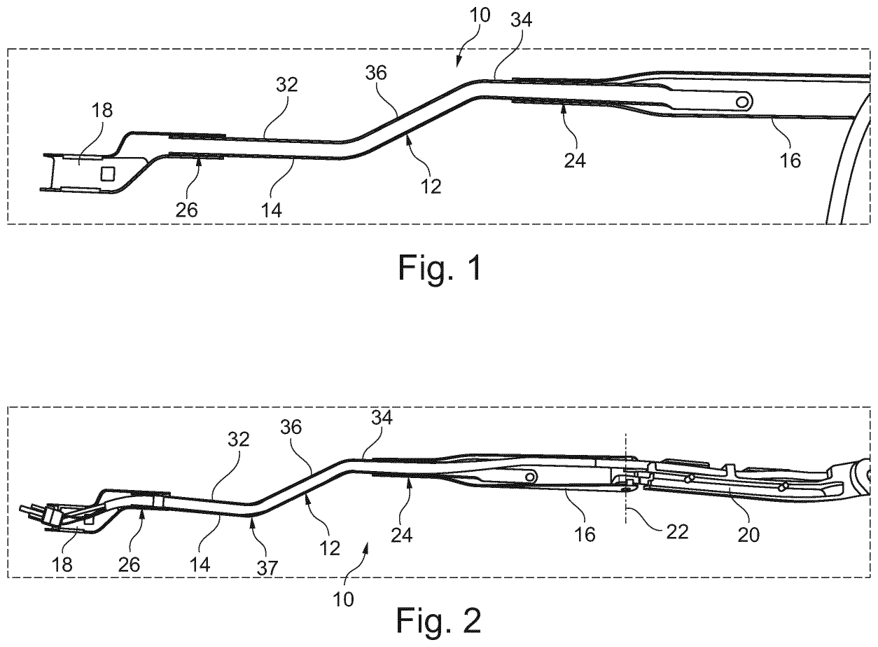

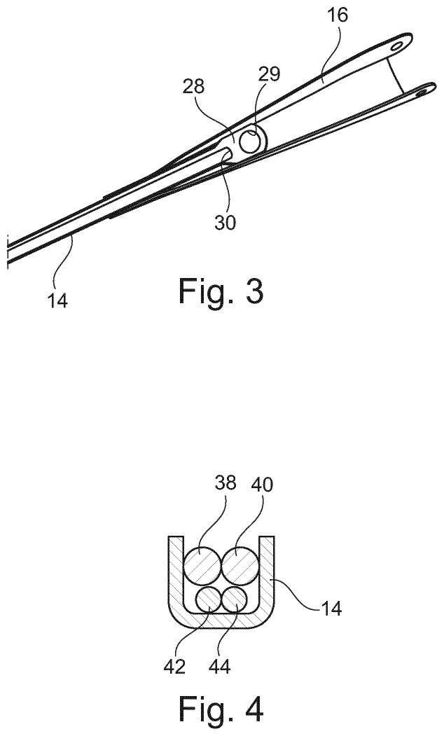

FIGS. 1 and 2 illustrate a wiper arm 10 for a wiper system of a vehicle. The wiper arm 10 has a wiper arm element 12 that consists of two interconnected components 14, 16. The first component 14 of the wiper arm element 12 is connected to an adapter element 18, which in turn serves for the exchangeable fastening of a wiper blade, not illustrated, which can be placed against a vehicle windscreen.

On that side of the second component 16 of the wiper arm element 12 which faces away from the first component 14, the second component 16 is connected to an attachment piece 20, which is connectable to a wiper shaft, likewise not illustrated (FIG. 2). The wiper arm element 12 and the attachment piece 20 are arranged so as to be pivotable with respect to each other about an axis 22. The two components 14, 16 of the wiper arm element 12 are each composed of sheet metal and are in the form of punched/bent parts. Both the first component 14 and the second component 16 each have a substantially U-shaped cross section. The axial end section of the first component 14 that faces the second component 16 of the wiper arm element 12 is accommodated in regions inside the cross section of the second component 16, and therefore a first connection region 24 is formed between the two components 14, 16 of the wiper arm element 12, as viewed in the longitudinal direction, in which connection region the two components 14, 16 overlap in a longitudinal direction.

The connection between the two components 14, 16 of the wiper arm element 12 preferably takes place by means of a weld (not illustrated) in the first connection region 24. By contrast, the connection between the first component 14 of the wiper arm element 12 and the adapter element 18 depends on the material of the adapter element 18.

As can be seen in particular with reference to FIG. 1, the adapter element 18 too has a U-shaped cross section, the size of which is adapted to the cross section of the first component 14 in such a manner that the first component 14 of the wiper arm element 12 is accommodated in a second overlapping region 26 in the cross section of the adapter element 18. If the adapter element 18 is likewise made of sheet metal and is in the form of a bent part, it is preferably provided that the connection between the first component 14 of the wiper arm element 12 and the adapter element 18 likewise takes place by means of a weld in the second connection region 26. If, by contrast, the adapter element 18 is made of plastic and is in the form of an injection moulded part, the connection between the adapter element 18 and the first component 14 of the wiper arm element 12 is preferably in the form of a bonded connection or a snap-on connection in the second connection region 26.

The cross section of the second component 16 of the wiper arm element 12 widens towards the attachment piece 20, wherein a fastening element 28 with an opening 29 is arranged inside the cross section of the second component 16. The fastening element 28 protrudes beyond the end side 30 of the first component 14 and is connected to the first component 14, for example by a weld. One end, not illustrated in the figures, of a spring element can be inserted into the opening 29 in the fastening element 28, the other end of which spring element is fastened, as known per se, to the attachment piece 20. A spring element of this type in the form of a tension spring serves for producing a required contact force of the wiper arm element 12 and therefore also of the wiper blade (not illustrated) to a vehicle windscreen in the operating position of the wiper arm element 12 or of the wiper blade.

The first component 14 of the wiper arm element 12 has two sections 32, 34 which are arranged parallel to each other and are connected to each other via a diagonally positioned intermediate section 36.

The shaping of a first component 14 formed in this manner from a metal profile strip 37 having a U-shaped cross section from a rectilinear original state into the final form illustrated in the figures takes place by means of a bending process.

By way of example, two hoses 38, 40 and two heating wires 42, 44 are received inside the cross section at least of the wiper arm element 12 or of the two components 14, 16, but preferably also inside the cross section of the adapter element 18 and of the attachment element 20, preferably by clamping action connections (FIG. 4). The two hoses 38, 40 serve for supplying at least one spray nozzle, which is arranged in the region of the wiper blade, with a cleaning medium, and the two heating wires 42, 44 for the current supply of a heatable wiper blade, as is known per se from the prior art.

Furthermore, it can be provided that the (open) cross section of the wiper arm element 12 and/or of the adapter element 18 is additionally covered or closed on the side facing the vehicle windscreen by a cover profile, not illustrated. This enables in particular a protected arrangement of the hoses 38, 40 and of the heating wires 42, 44. A cover element of this type can be fastened, for example, by a snap-on connection on the wiper arm element 12.

The wiper arm 10 described thus far can be altered or modified in a wide variety of ways without departing from the concept of the invention. The latter consists in providing a wiper arm element 12 which consists of two components 14, 16 which are interconnected in a connection region 24.

### LIST OF REFERENCE SIGNS

10 wiper arm
12 wiper arm element
14 first component
16 second component
18 adapter element
20 attachment piece
22 axis
24 first connection region
26 second connection region
28 fastening element
29 opening
30 end side
32 section
34 section
36 intermediate section
37 profile strip
38 hose
40 hose
42 heating wire
44 heating wire

1. A wiper arm for a wiper system of a vehicle, comprising:
a wiper arm element which is configured connecting, in an articulated manner, an attachment piece coupled to a wiper shaft, wherein the wiper arm element is coupled to an adapter element for connecting to a wiper blade,
wherein the wiper arm element consists of two separate components comprising a first component, which is connected to the adapter element, and a second component, which attaches to the first component on the side facing away from the adapter element, and
wherein the first component is formed from a profile strip having a U-shaped cross section, wherein the two components overlap in a longitudinal direction in a first connection area.

2. The wiper arm according to claim 1, wherein the adapter element has, at least on the side facing the first component of the wiper arm element, a U-shaped cross section, wherein the first component and the adapter element overlap in a longitudinal direction in a second connection area.

3. The wiper arm according to claim 1, wherein the two components of the wiper arm element and the adapter element are made of metal and connected to one another by welds.

4. The wiper arm according to claim 1, wherein the two components of the wiper arm element are made of metal and connected to one another by a weld, that the adapter element is made of plastic, and that the wiper arm element and the adapter element are connected to one another by a snap-on connection or a bonded connection.

5. The wiper arm according to claim 1, wherein the first component of the wiper arm element has two sections arranged parallel to each other, which are connected to each other by a diagonally positioned intermediate section.

6. The wiper arm according to claim 2, wherein the cross section of the first component of the wiper arm element is received in the two connection areas in a form-fitting manner inside the U shaped cross section of the adapter element and of the second component of the wiper arm element.

7. The wiper arm according to claim 1, wherein a fastening element for a spring element is arranged on the first component of the wiper arm element on the side facing the second component, wherein the fastening element protrudes axially above the end face of the first component facing the second component and is received inside the U-shaped cross section of the second component.

8. The wiper arm according to claim 1, wherein at least one hose for a cleaning medium and optionally heating wires for a wiper blade are arranged inside the cross section of the wiper arm element.

9. The wiper arm according to claim 8, wherein the at least one hose is held in the wiper arm element by a clamping action connection.

10. A method for manufacturing a wiper arm that is configured according to claim 1, the method comprising:
reshaping the first component of the wiper arm element, by a bending process, from a metal profile strip having a U-shaped cross section from a rectilinear original state into a final form.

11. The method according to claim 10, wherein the bending process is effected in a plane extending parallel to a base section of the profile strip.
